(19) United States
(12) Patent Application Publication
(10) Pub. No.: US 2005/0264258 A1
(43) Pub. Date: Dec. 1, 2005

(54) Battery extension assembly

(76) Inventor: Ta-Kuang Yeh, Taipei City (TW)

Correspondence Address: Yi-Wen Tseng, 4331 Stevens Battle Lane, Fairfax, VA, 22033, US

(21) Appl. No.: 10/852,474

(22) Filed: May 25, 2004

(51) Int. Cl. H02J 7/00

(52) U.S. Cl. 320/112

(57) ABSTRACT

A battery extension assembly for extending the usage of a battery of smaller size is provided. The battery extension assembly includes a hollow cylindroid body, a confining structure and an elastic holding member. The cylindroid body has an outer radius larger than the outer radius of the battery. The confining structure is formed on the cylindroid body for aligning the battery in the cylindroid body. The elastic holding member is formed on the internal surface of the cylindroid body extending towards the center of the cylindroid body. The elastic holding member then clamps the side surface of the battery, thus holding the battery inside of the cylindroid body. Therefore, the battery is applicable in a battery holder for the batteries having the same size as that of the cylindroid body.

### BACKGROUND OF THE INVENTION

The present invention relates generally to a battery extension assembly, and more particularly to a battery extension assembly that is used for a smaller size battery to be adapted to a battery holder for larger size batteries, so as to extend the usage of the smaller size battery.

The most commonly seen batteries in a grocery store are of the sizes of D, C, AA and AAA. Although each of the batteries of different sizes provides a voltage source of 1.5 V, the dimension differences requires the battery of one size to work with a battery holder with a corresponding size.

In order to extend the usage of a smaller size battery to a battery holder for larger size batteries, the smaller size battery is conventionally put into a cylindroid body having the same size as that of the larger battery. The cylindroid body includes an outer radius larger than that of the smaller size battery so as to enclose the smaller size battery therein. The smaller size battery may thus be used in a larger battery holder.

However, the above-mentioned cylindroid body includes an internal cavity formed inside of the cylindroid body for holding a smaller size battery. When the battery is disposed therein, the internal cavity may form a surface contact with the battery. If the internal cavity is too small, it is difficult to dispose the battery in and out of the cylindroid body. On the other hand, if the internal cavity is too large, then the battery may not be firmly disposed inside of the cylindroid body. Consequently, the battery is easy to slide off from the internal cavity of the cylindroid body. Moreover, the positive or negative pole of the battery may easily lose contact with the conducting foil of an electronic product. Therefore, an improved battery extension assembly is needed.

### BRIEF SUMMARY OF THE INVENTION

The present invention is to provide a battery extension assembly so as to enhance the stability and accessibility of a battery on an extension assembly. In accordance with the battery extension assembly, the battery is properly installed in the extension assembly, and easily disposed and aligned therein. By employing the battery extension assembly of the present invention, the battery is very unlikely to deviate from its installed position. Thus, the conduction contact is maintained.

The battery extension assembly of the present invention includes a cylindroid body having a cavity formed therein and having an outer radius larger than the outer radius of the battery, the cavity forming an internal surface of the cylindroid body; a confining structure formed on the cylindroid body for aligning the battery in the cylindroid body; and an elastic holding member formed on the internal surface of the cylindroid body extending towards the center of said cylindroid body, clamping the side surface of the battery, thus holding the battery inside of the cylindroid body. Therefore, the battery is applicable in a battery holder for the batteries having the same size as that of the cylindroid body.

### BRIEF DESCRIPTION OF THE DRAWINGS

FIG. 1 illustrates a perspective view of a battery extension assembly and a battery that are separated from each other, in accordance with the first embodiment of the present invention.

FIG. 2 illustrates a perspective view of a battery extension assembly in combination with a battery, in accordance with the first embodiment of the present invention.

FIG. 3 is a partial cross-sectional view of FIG. 2.

FIG. 4 illustrates a cross-sectional side view of a battery extension assembly and a battery, in accordance with the first embodiment of the present invention.

FIG. 5 illustrates a cross-sectional top view of a battery extension assembly and a battery, in accordance with the first embodiment of the present invention.

FIG. 6 illustrates a perspective view of a battery extension assembly and a battery, in accordance with the second embodiment of the present invention.

FIG. 7 illustrates a perspective view of a battery extension assembly in combination with a battery, in accordance with the first embodiment of the present invention.

FIG. 8 is a partial cross-sectional view of FIG. 7.

FIG. 9 illustrates a cross-sectional side view of a battery extension assembly and a battery, in accordance with the second embodiment of the present invention.

FIG. 10 illustrates a cross-sectional top view of a battery extension assembly and a battery, in accordance with the second embodiment of the present invention.

### DETAILED DESCRIPTION OF THE INVENTlON

In order to better understanding the features and technical contents of the present invention, the present invention is hereinafter described in detail by incorporating with the accompanied drawings. However, the accompanied drawings are only for the convenience of illustration and description, no limitation is intended thereto.

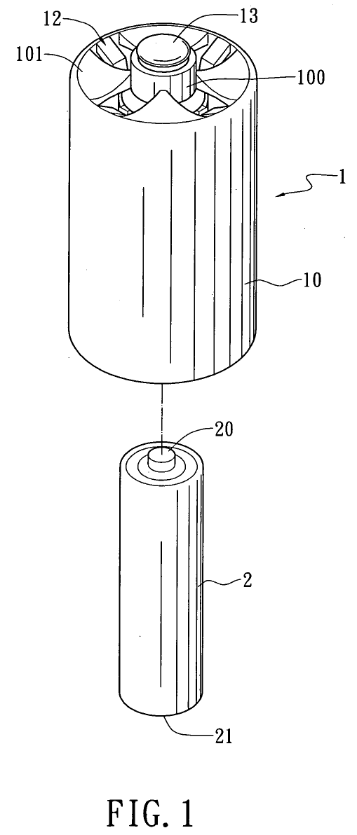

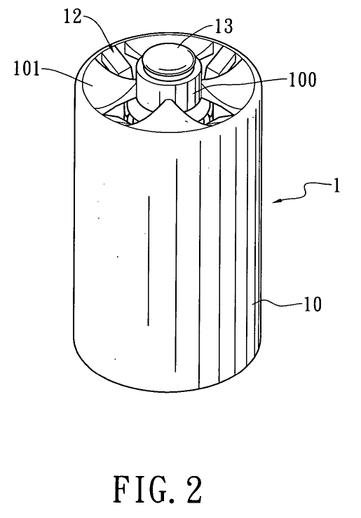

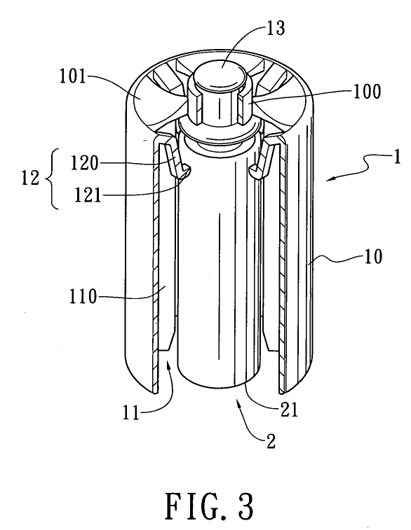

Referring to FIG. 1, FIG. 2 and FIG. 3, a battery extension assembly and a battery in accordance with the first embodiment of the present invention are illustrated in different views. The battery extension assembly 1 is primarily comprised of a cylindroid body 10 having a dimension relatively larger than that of a battry 2, so as to dispose the battery 2 into the cylindroid body 10. The battery 2 may then be adapted to a larger battery holder (not shown), thereby extending the use of the smaller size battery 2.

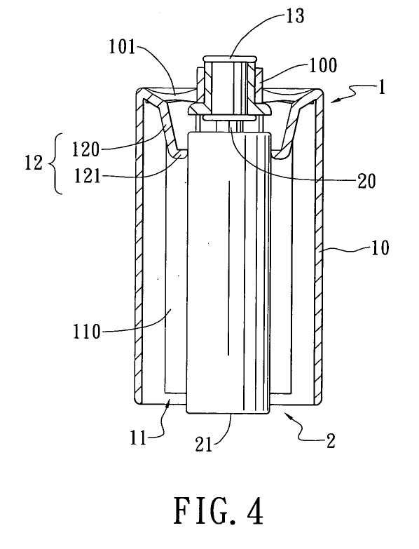

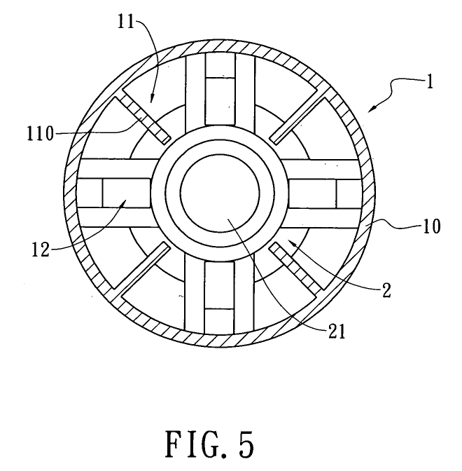

Referring to FIG. 4 and FIG. 5, the cylindroid body 10 of the battery extension assembly 1 comprises an outer radius at least larger than that of the battery 2. In this particular embodiment, the cylindroid body 10 comprises an outer radius and a height substantially the same as that of the size D battery, while the battery 2 is size AA battery. Furthermore, the cylindroid body 10 comprises a hollow central portion, so as to dispose the battery 2 therein. Consequently, the battery 2 may now be installed and used in a battery holder for size D batteries.

The particular feature of the present invention is in that the cylindroid body 10 comprises a confining structure 11 and a plurality of elastic holding members 12, so as to enhance the stability and accessibility of the battery 2 disposed in the cylindroid body 10. In this particular embodiment, the confining structure 11 comprises a plurality of ribs 110 arranged on the internal surface of the cylindroid body 10. Each rib 110 extends from the internal surface of the cylindroid body 10 to the center portion thereof, as shown in FIG. 5, keeping a free space to be occupied by the battery 2. The battery 2 may thus be confined inside of the cylindroid body 10, and properly aligned therein.

The elastic holding member 12 comprises an elastic arm 120 connected with the internal surface of the cylindroid body 10, and a holding portion 121 formed at one end of the elastic arm 120, as shown in FIG. 3 and FIG. 4. The elastic holding members 12 are also disposed on the internal surface of the cylindroid body 10 and are extended to the center portion of the cylindroid body 10. The elastic holding members 12 and the ribs 110 are disposed next to each other on the internal surface of the cylindroid body 10. The side surface of the battery 2 may be clamped from several directions by means of the elastic holding member 12. The battery 2 may then be hold inside of the cylindroid body 10 by employing the elastic force of the elastic holding member 12. Therefore, the battery 2 is difficult to fall apart from the cylindroid body 10.

Furthermore, in this particular embodiment, the upper portion of the cylindroid body 10 comprises a electrically conductive portion 12, acting as an extension of the positive pole 20 of the battery 2. The electrically conductive portion 13 is disposed on a hollow canula 100. The canula 100 is located at the upper portion of the cylindroid body 10, and is connected to the cylindroid body 10 through a plurality of supporting portions 101, so as to dispose the electrically conductive portion 13. In addition, the battery 2 is disposed into the cylindroid body 10 from the bottom portion thereof. After the battery 2 is disposed into the cylindroid body 10, the negative pole 21 of the battery 2 obtrudes the bottom portion of the cylindroid body 10, as shown in FIG. 4, for contacting the corresponding negative electrode of a battery holder.

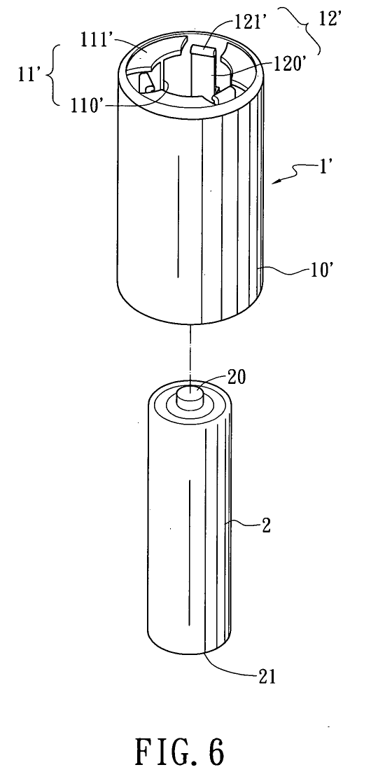

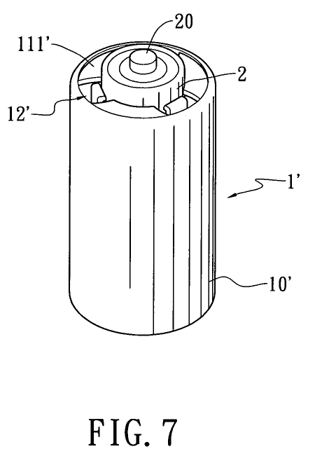

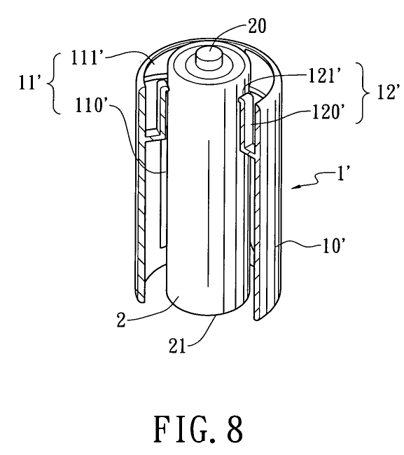

As shown in FIG. 6, FIG. 7 and FIG. 8, the battery extension assembly in accordance with the second embodiment of the present invention is illustrated in different views. In accordance with the second embodiment of the present invention, the battery extension assembly 1′ comprises a cylindroid body 10′ having the same outer radius and height as that of the size C battery. The battery 2 is a size AA battery, for example.

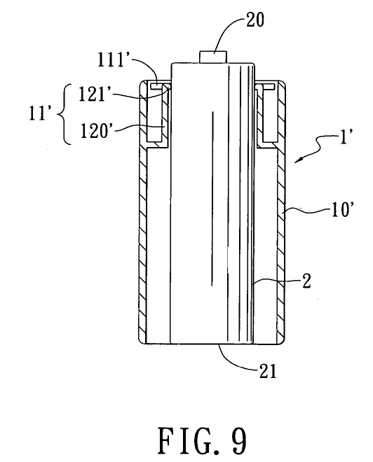

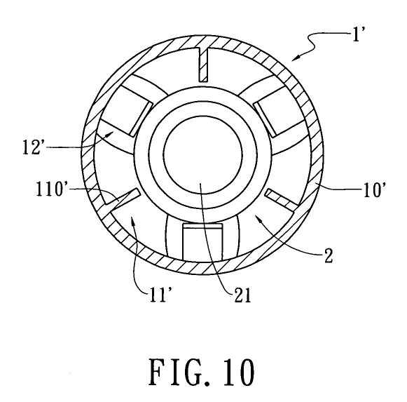

Referring to FIG. 9 and FIG. 10, since the height of a size C battery is the same as that of a size AA battery, no electrically conductive portion 13 as in the first embodiment of the present invention is needed. The positive pole 20 of the battery 2 obtrudes the upper portion of the cylindroid body 10′ immediately after installation. Moreover, in order to enhance of accessibility of the battery 2 disposed in the cylindroid body 10′, a confining structure 11′ comprises a protruding tab 111′ formed at the upper portion of the cylindroid body 10′ perpendicular to the rib 110′. The inner rim of the protruding tab 111′ is in concave shape corresponding to the side surface of the battery 2. In this particular embodiment, each of the elastic holding member 12′ also comprises an elastic arm 120′ connected to the internal surface of the cylindroid body 10′, and a holding portion 121′ formed at one end of the elastic arm 120′. Each elastic arm 120′ of the elastic holding member 12′ is in “L” shape.

In summary, the battery extension assembly of the present invention may indeed overcome one or more of the drawbacks set forth above. Therefore, the subject matter sought to be patented in this application indeed satisfies the novelty and non-obviousness requirements as set forth in the patent law. A grant of patent is thus respectively requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

1. A battery extension assembly for extending the usage of a battery of smaller size, said battery extension assembly comprising:
a cylindroid body having a cavity formed therein and having an outer radius larger than the outer radius of the battery, said cavity forming an internal surface of said cylindroid body;
a confining structure formed on said cylindroid body for aligning the battery in said cylindroid body; and
an elastic holding member formed on the internal surface of said cylindroid body extending towards the center of said cylindroid body, clamping the side surface of the battery, whereby the battery is hold inside of said cylindroid body, and whereby the battery is applicable in a battery holder for the batteries having the same size as that of said cylindroid body.

2. The battery extension assembly as recited in claim 1, wherein the upper portion of said cylindroid body comprises an electrically conductive portion.

3. The battery extension assembly as recited in claim 2, wherein said electrically conductive portion is disposed on a canula formed on the central upper portion of said cylindroid body, and connected to said cylindroid body by means of a plurality of supporting portions.

4. The battery extension assembly as recited in claim 1, wherein said confining structure comprises a plurality of ribs arranged on the internal surface of said cylindroid body.

5. The battery extension assembly as recited in claim 4, wherein said ribs extends to the center portion of said cylindroid body, and retains a free space for disposing the battery.

6. The battery extension assembly as recited in claim 4, wherein said confining structure comprises a protruding tab formed in the upper portion of said cylindroid body perpendicular to said ribs, said protruding tab being in concave shape corresponding to the side surface of the battery.

7. The battery extension assembly as recited in claim 1, wherein said elastic holding member comprises an elastic arm connected to the internal surface of said cylindroid body, and a holding portion formed at one end of said elastic arm.

8. The battery extension assembly as recited in claim 7, wherein said elastic arm is in L-shape.
